(19) United States
(12) Patent Application Publication
(10) Pub. No.: US 2024/0176984 A1
(43) Pub. Date: May 30, 2024

(54) DATA PROCESSING DEVICE AND METHOD, AND RELATED PRODUCT

(71) Applicant: CAMBRICON TECHNOLOGIES CORPORATION LIMITED, Beijing (CN)

(72) Inventors: Xiaomeng LIU, Shanghai (CN); Ming LI, Shanghai (CN); Xiwen YU, Shanghai (CN); Zhize CHEN, Shanghai (CN); Wenjuan DAI, Shanghai (CN); Qingwei HE, Shanghai (CN); Le YIN, Shanghai (CN); Jiangmin ZHOU, Shanghai (CN)

(21) Appl. No.: 18/551,760

(22) PCT Filed: Mar. 25, 2022
(86) PCT No.: PCT/CN2022/082930

§ 371 Date: Sep. 21, 2023

(30) Foreign Application Priority Data
Mar. 26, 2021 (CN) 202110328005.7

(51) Int. Cl. G06N 3/04

(52) U.S. Cl. CPC G06N 3/04

(57) ABSTRACT

The present disclosure discloses a data processing apparatus, a method, and related products. The data processing apparatus is used as a computing apparatus and is included in a combined processing apparatus. The combined processing apparatus further includes an interface apparatus and other processing apparatus. The computing apparatus interacts with other processing apparatus to jointly complete a computing operation specified by a user. The combined processing apparatus further includes a storage apparatus. The storage apparatus is respectively connected to the computing apparatus and other processing apparatus and is configured to store data of the computing apparatus and other processing apparatus. The solution of the present disclosure reduces IO time at runtime and memory requirements by means of block local rearrangement.

### CROSS REFERENCE OF RELATED APPLICATION

The present application is a 371 of international application number PCT/CN2022/082930, filed Mar. 25, 2022, which claims priority to Chinese Patent Application No. 2021103280057 with the title of “Data Processing Apparatus, Method, and Related Product” filed on Mar. 26, 2021.

### TECHNICAL FIELD

The present disclosure generally relates to the field of data processing. More specifically, the present disclosure relates to a data processing apparatus, a method for performing a neural network model, a chip, and a board card.

### BACKGROUND

At present, a transformer model has been widely used in natural language processing (NLP), such as machine translation, question answering systems, text summarization and speech recognition. The transformer model uses an encoder-decoder architecture, and an attention mechanism is included in both the encoder and the decoder.

During the inference of the transformer model, the decoder caches key (K) information and value (V) information of each time step. The decoder uses a beam search method to decode, so each time step selects several best beams as decoding inputs of a next time step. At this time, the cached key information and value information are rearranged according to the selected best beams, so that corresponding key information and value information may be read for computing when decoding in the next time step.

The above rearrangement process needs to read the K/V and then write the K/V after rearrangement according to the best beams. However, in some situations, sizes of the K and V are relatively large, so the IO bottleneck caused by the above rearrangement process is very obvious. Therefore, it is expected to provide an improved solution to at least alleviate the IO bottleneck.

### SUMMARY

In order to at least address one or more technical problems mentioned above, the present disclosure provides a block rearrangement solution in many aspects, thereby reducing the amount of IO generated by each rearrangement and avoiding IO bottlenecks.

A first aspect of the present disclosure provides a data processing apparatus, including: a processing unit, configured to run a neural network model, where the neural network model includes a decoder based on an attention mechanism, and the decoder uses a beam search method to decode; and a first storage unit, configured with N storage blocks, where N>1, and each storage block is separately associated with several successive time steps to cache intermediate variables generated by the decoder during the associated time steps; where the processing unit is further configured to: according to B candidate output sequences of the decoder selected at a current time step, where B>1, rearrange B groups of intermediate variables corresponding to the B candidate output sequences in the associated storage block of the current time step; and based on the B candidate output sequences, read B groups of intermediate variables of a predetermined time step range from a corresponding storage block of the storage unit to perform decoding processing of a next time step.

A second aspect of the present disclosure provides a chip, including the data processing apparatus of any embodiment of the first aspect.

A third aspect of the present disclosure provides a board card, including the chip of any embodiment of the second aspect.

A fourth aspect of the present disclosure provides a method for performing a neural network model, where the neural network model includes a decoder based on an attention mechanism, and the decoder uses a beam search method to decode, and the method includes: dividing a storage unit into N storage blocks, where N>1, and each storage block is separately associated with several successive time steps to cache intermediate variables generated by the decoder during the associated time steps; selecting B candidate output sequences from decoding results of the decoder at a current time step, where B>1; according to the B candidate output sequences, rearranging B groups of intermediate variables corresponding to the B candidate output sequences in the associated storage block of the current time step; and based on the B candidate output sequences, reading B groups of intermediate variables of a predetermined time step range from a corresponding storage block of the storage unit to perform decoding processing of a next time step.

Through the data processing apparatus, chip, board card and method for performing the neural network model mentioned above, through block storage of intermediate variables required to be rearranged and rearrangement of the intermediate variables within blocks, the solution of the present disclosure may reduce the amount of IO caused by rearrangement. Further, each rearrangement is performed in situ storage block, so there is no need to configure additional storage space to support the rearrangement, thus reducing memory requirements.

Additionally, the method provided in the embodiment of the present disclosure has strong generality and has no special requirements for hardware, so the method may be applied to any hardware system.

### BRIEF DESCRIPTION OF DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 shows a structural diagram of a board card according to an embodiment of the present disclosure.

FIG. 2 shows a structural diagram of an integrated circuit apparatus according to an embodiment of the present disclosure.

FIG. 3 shows a schematic diagram of an internal structure of a processor core of a single-core or multi-core computing apparatus according to an embodiment of the present disclosure.

FIG. 4 shows an exemplary architecture of a transformer model.

FIG. 5 illustrates a concept of beam search.

FIG. 6 illustrates a known rearrangement strategy of beam search.

FIG. 7 illustrates rearrangement processing according to an embodiment of the present disclosure.

FIG. 8 shows an exemplary structural diagram of a data processing apparatus according to an embodiment of the present disclosure.

FIG. 9 shows an exemplary flowchart of a method for performing a neural network model according to an embodiment of the present disclosure.

### DETAILED DESCRIPTION OF EMBODIMENTS

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

Specific implementations of the present disclosure will be described in detail in combination with drawings below.

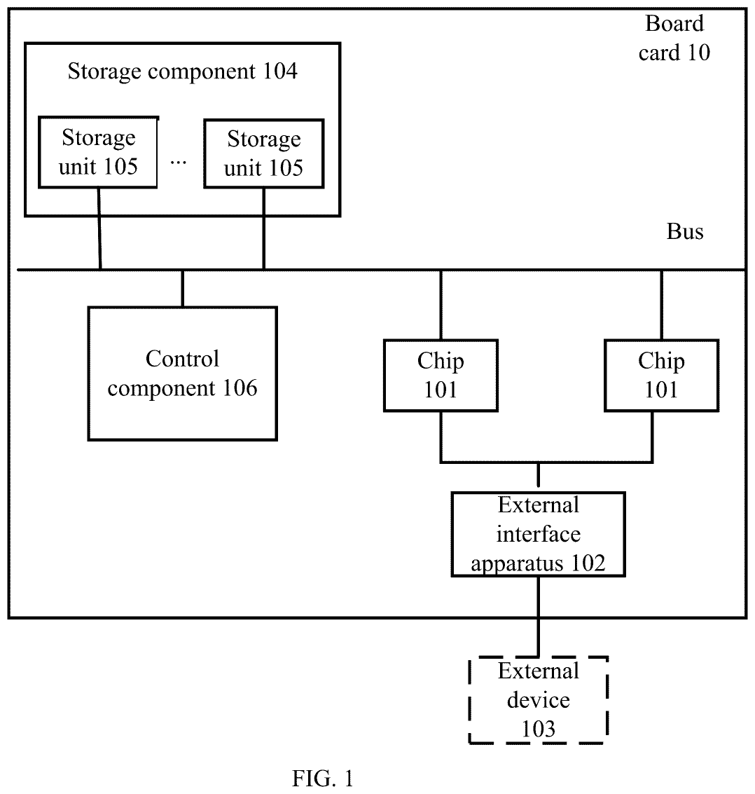

FIG. 1 is a structural diagram of a board card 10 according to an embodiment of the present disclosure. As shown in FIG. 1, the board card 10 includes a chip 101, which is a system on chip (SoC), or called an on-chip system, and integrates one or a plurality of combined processing apparatuses. The combined processing apparatus is an artificial intelligence operation unit, which is configured to support various deep learning algorithms and various machine learning algorithms and meet requirements of intelligent processing in complex scenarios in computer vision, speech, natural language processing, data mining, and other fields. In particular, deep learning technology is widely used in the field of cloud intelligence. A notable feature of cloud intelligence applications is the large amount of input data, which has high requirements for storage capacity and computing power of a platform. The board card 10 of this embodiment is suitable for the cloud intelligent applications and has huge off-chip storage, huge on-chip storage and great computing power.

The chip 101 is connected to an external device 103 through an external interface apparatus 102. The external device 103 may be, for example, a server, a computer, a camera, a monitor, a mouse, a keyboard, a network card, or a WIFI interface. To-be-processed data may be transferred from the external device 103 to the chip 101 through the external interface apparatus 102. A computing result of the chip 101 may be transferred back to the external device 103 through the external interface apparatus 102. According to different application scenarios, the external interface apparatus 102 may have different interface forms, such as a peripheral component interface express (PCIe) interface, and the like.

The board card 10 further includes a storage component 104 used for storing data. The storage component 104 includes one or a plurality of storage units 105. The storage component 104 is connected to and transfers data to a control component 106 and the chip 101 through a bus. The control component 106 in the board card 10 is configured to regulate and control a state of the chip 101. As such, in an application scenario, the control component 106 may include a micro controller unit (MCU).

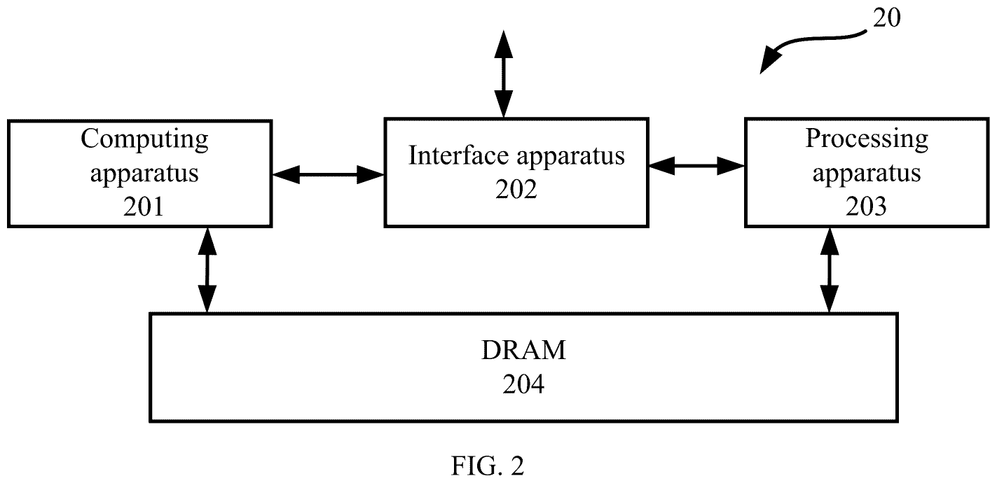

FIG. 2 is a structural diagram of a combined processing apparatus in the chip 101 of this embodiment. As shown in FIG. 2, the combined processing apparatus 20 includes a computing apparatus 201, an interface apparatus 202, a processing apparatus 203, and a dynamic random access memory (DRAM) 204.

The computing apparatus 201 is configured to perform an operation specified by a user. The computing apparatus 201 is mainly implemented as a single-core intelligent processor or a multi-core intelligent processor and is configured to perform deep learning computing or machine learning computing. The computing apparatus 201 interacts with the processing apparatus 203 through the interface apparatus 202 to jointly complete the operation specified by the user.

The interface apparatus 202 is configured to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general processing apparatus and performs basic controls, including but not limited to, moving data, starting and/or stopping the computing apparatus 201. According to different implementations, the processing apparatus 203 may be a central processing unit (CPU), a graphics processing unit (GPU), or one or more of other general and/or dedicated processors. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, the number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when the computing apparatus 201 and the processing apparatus 203 are considered together, both the computing apparatus 201 and the processing apparatus 203 may be viewed as forming a heterogeneous multi-core structure.

The DRAM 204 is configured to store to-be-processed data. The DRAM 204 is a double data rate (DDR) memory with a size of 16G or more than 16G generally. The DRAM 204 is configured to save data of the computing apparatus 201 and/or the processing apparatus 203.

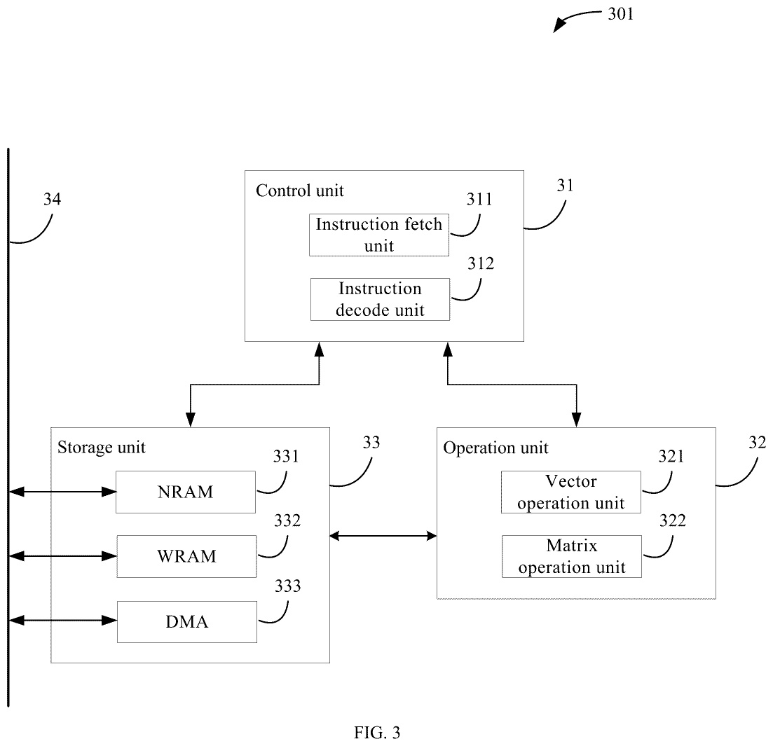

FIG. 3 shows a schematic diagram of an internal structure of a processor core when the computing apparatus 201 is a single-core apparatus or a multi-core apparatus. A computing apparatus 301 is configured to process input data in computer vision, speech, natural language, and data mining. The computing apparatus 301 includes three units: a control unit 31, an operation unit 32, and a storage unit 33.

The control unit 31 is configured to coordinate and control work of the operation unit 32 and the storage unit 33 to complete a deep learning task. The control unit 31 includes an instruction fetch unit (IFU) 311 and an instruction decode unit (IDU) 312. The IFU 311 is configured to acquire an instruction from the processing apparatus 203. The IDU 312 is configured to decode the instruction acquired and send a decoding result as control information to the operation unit 32 and the storage unit 33.

The operation unit 32 includes a vector operation unit 321 and a matrix operation unit 322. The vector operation unit 321 is configured to perform a vector operation and supports complex operations such as vector multiplication, addition, and nonlinear conversion. The matrix operation unit 322 is responsible for core computing of deep learning algorithms, such as matrix multiplication and convolution.

The storage unit 33 is used to store or move related data and includes a neuron storage unit (neuron random access memory (RAM), NRAM) 331, a parameter storage unit (weight RAM, WRAM) 332, and a direct memory access unit (direct memory access, DMA) 333. The NRAM 331 is configured to store input neuron, output neuron, and an intermediate result after computing. The WRAM 332 is configured to store a convolution kernel of a deep learning network, which is a weight. The DMA 333 is connected to the DRAM 204 through a bus 34 and is responsible for data moving between the computing apparatus 301 and the DRAM 204.

Based on the above hardware environment, the embodiment of the present disclosure provides a data processing solution, where when a beam search decoding method is applied to a neural network model such as a transformer model, block caching and rearrangement of intermediate variables required to be rearranged based on optimal candidate beams are performed, thereby reducing the amount of IO of rearrangement, reducing overall processing time, and optimizing processing performance.

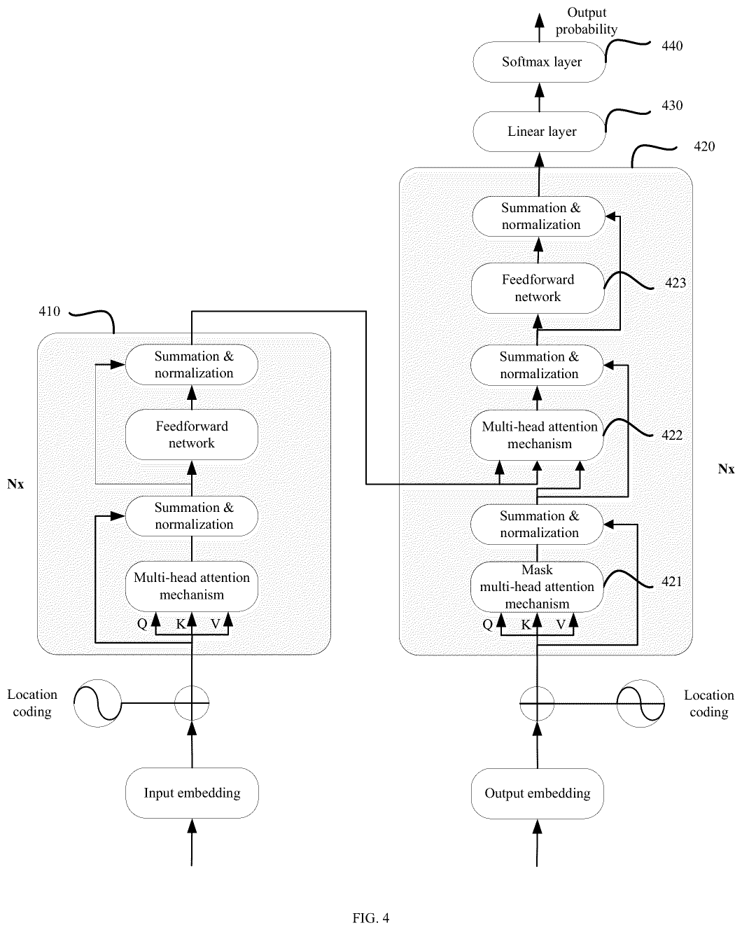

FIG. 4 shows an exemplary architecture of a transformer model.

As shown in the figure, the transformer model uses an encoder-decoder architecture. The left half of FIG. 4 is framed in Nx, representing a layer of encoder 410, and the right half of FIG. 4 is framed in Nx, representing a layer of decoder 420. In an original transformer model, Nx=6, which means that there are 6 layers of encoders and 6 layers of decoders. In some models based on deformations of the transformer model, there may be different layers of encoders and decoders. The transformer model is widely used in existing technologies. For the sake of simplicity, only the portions relevant to the embodiment of the present disclosure are described herein.

Each layer of decoder 420 consists of three main parts: a multi-head self-attention mechanism 421, a multi-head context attention mechanism 422, and a feedforward network 423.

The multi-head self-attention mechanism 421 receives an output of a previous layer of decoder. An input of a first layer of decoder contains only word information before a current position. The purpose of this design is that the decoder performs decoding sequentially, and a current output of the decoder may only be based on a part that has been output. In other words, for a sequence, at a time step t, the output of the decoding should depend only on an output before the t but not on an output after the t. For example, in a transformer model applied to machine translation, the decoder in turn translates a next word i+1 based on currently translated words 1˜i.

In the multi-head self-attention mechanism 421, a tensor is used to compute self-attention. In computing the self-attention, three tensors or intermediate variables are involved: a query (Q) tensor, a key (K) tensor and a value (V) tensor. The Q, K, and V are obtained by linear transformations of an input of the self-attention mechanism 421.

An output of a last layer of decoder 420 is input into a linear layer 430 to be converted into an ultra-long tensor (such as a vocabulary length) and then is input into a softmax layer 440 to be converted into a probability. Finally, by using an appropriate strategy, an appropriate output is selected.

In the above decoding process, the output of the model is obtained one time step after another, and a result of a previous time step also affect a result of a later time step. In other words, at each time step, what the model gives is a conditional probability based on a history-generated result. In a text generation task such as machine translation, possible output types of each time step constitute a vocabulary size (v), and there are a total of T*v possible results obtained by random generation of T steps. Taking Chinese text generation as an example, a value of the v is about 5000-6000, which is a count of commonly used Chinese characters.

Common decoding strategies may include exhaustive search, greedy search, beam search, and so on. With such a large base in the example above, it is not practical to traverse the entire generation space by using the exhaustive search. The greedy search is to take an output with the greatest conditional probability for each time step, and then use results from the start to the current step as the input to obtain the output of the next time step until the model gives a sign of the end of generation. Obviously, since the greedy search discards most possible solutions, this present-focused strategy may not guarantee that a resulting sequence probability is optimal.

The beam search is an improvement on the greedy search, which at each time step, no longer only retains one output with the current greatest probability, but retains a plurality of outputs, where the retained outputs may be called best beams, and a count of the best beams may be called a beam width B, a beam width or size. It may be understood that when B=1, the beam search degenerates into the greedy search.

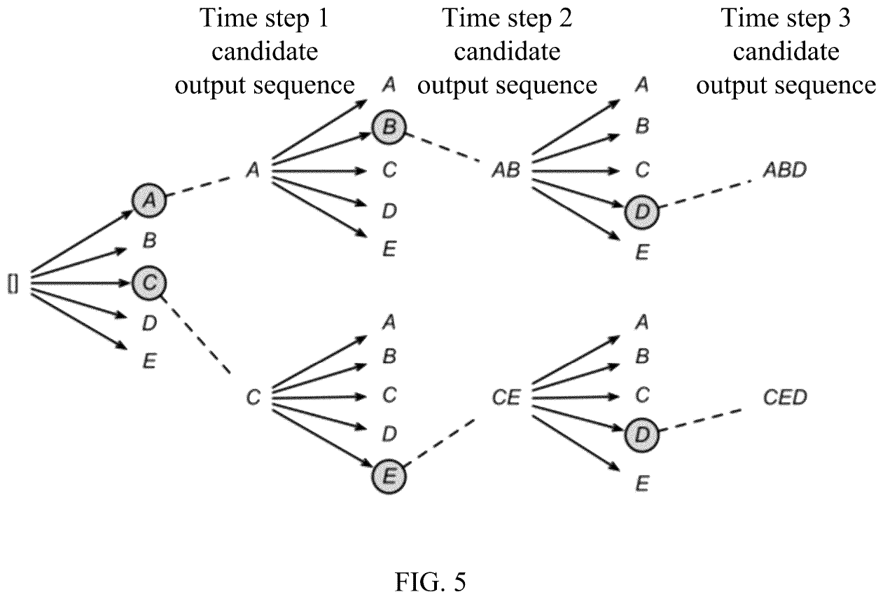

FIG. 5 illustrates a concept of the beam search. In the example of FIG. 5, assuming that each time step has a total of 5 possible outputs including ABCDE, which means that a vocabulary size is 5, and each time step will retain two sequences with an optimal conditional probability up to a current time step, which is B=2 in the example of the figure.

As shown in the figure, at a first time step, two words with the greatest conditional probability of the current time step are selected. In this example, A and C are the optimal two. As such, two results [A] and [C] are obtained, and the other three are discarded.

At a second time step, generation is continued based on these two results. In this branch A, five candidates may be obtained: [AA], [AB], [AC], [AD], and [AE], and in the same way, in C, five candidates may be obtained. At this time, two optimal candidates are selected and retained from these ten candidates, which are [AB] and [CE] in the figure.

In the same way, at a third time step, two optimal candidates will be retained again from new ten candidate results, and finally, two results [ABD] and [CED] are obtained.

The above describes the basic concept of the beam search. The beam search may be used as the decoding strategy of the decoder of the transformer model. It may be known from the above description in combination with FIG. 4 that in the decoder based on the attention mechanism, the decoding of the next time step is based on output decoding results of previous time steps. More specifically, in the self-attention mechanism of the decoder, intermediate variables computed before the current time step are used, such as the K variable and the V variable. Therefore, in order to speed up processing, by caching intermediate variables corresponding to decoding results before the current time step, repeated computing may be reduced, and processing efficiency may be improved.

In order to quickly acquire intermediate variables participating in the decoding of the next time step, in an existing beam search operation, information of the cached intermediate variables may be rearranged according to the best beams selected by the current time step. Through rearrangement, intermediate variables corresponding to these best beams (intermediate variables that produce these best beams) are arranged in front of memory, so that the intermediate variables may be read when the decoding processing of the next time step is performed.

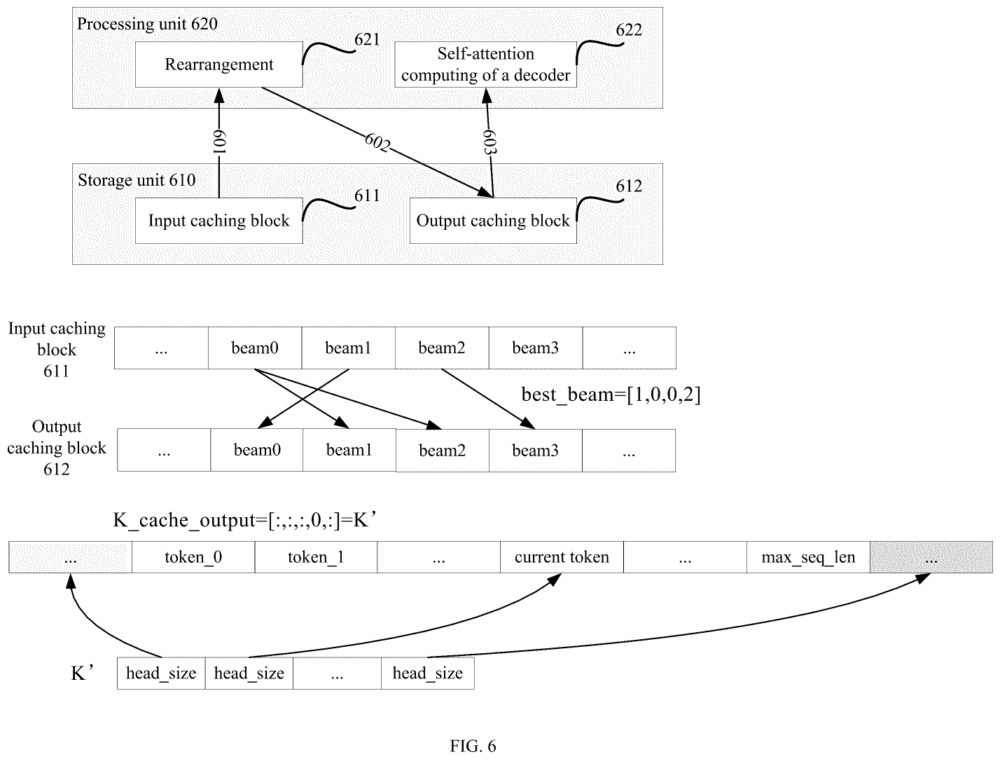

FIG. 6 illustrates a known rearrangement strategy of beam search. In the example of FIG. 6, a key (K) tensor is used as an example. In this example, it is assumed that a beam width B=4, best beams determined by a current time step best_beam=[1,0,0,2], which means that current four best beams come from previous beam 1, beam 0, beam 0, and beam 2 in sequence respectively.

As shown in the figure, in a storage unit 610, two caching blocks 611 and 612 are required to cache an input K tensor and an output K tensor for decoding, respectively. These two caching blocks are used interchangeably to rearrange the K tensor based on selected best beams at each time step.

The figure shows a corresponding memory operation. Specifically, as shown by an arrow 601, during rearrangement, the cached K tensor is required to be read from the input caching block 611. Next, rearrangement 621 is performed in a processing unit 620, which means that a corresponding K tensor is rearranged to correspond to the best beams according to the index indication of the best beams. The rearranged K tensor is written again to the output caching block 612, as shown by an arrow 602. Then, during decoding in a next step, the corresponding K tensor is read from the output caching block 612 to perform corresponding self-attention computing 622, as shown by an arrow 603.

FIG. 6 also shows information in the input caching block 611 and the output caching block 612 before and after rearrangement. As shown in FIG. 6, before rearrangement, the input caching block 611 stores K tensors of four best beams corresponding to a previous time step in sequence, where a beam0 stores a K tensor sequence corresponding to a first best beam, a beam1 stores a K tensor sequence corresponding to a second best beam, and so on. There is an index of best beams of a current time step best_beam=[1,0,0,2], indicating that a first best beam beam0 of the current time comes from a beam1 of a previous time step, a second best beam beam1 of the current time comes from a beam0 of the previous time step, a third best beam beam2 of the current time also comes from the beam0 of the previous time step, and a fourth best beam beam3 of the current time comes from a beam2 of the previous time step. Therefore, as shown by arrows in the figure, the beam1 of the previous time step is written to the beam0 of the output caching block 612, the beam0 of the previous time step is written to the beam1 of the output caching block 612, the beam0 of the previous time step is written to the beam2 of the output caching block 612, and the beam2 of the previous time step is written to the beam3 of the output caching block 612.

The K tensor is a piece of high-dimensional data. In some situations, dimensions of the K tensor include a batch size (batch_size), a beam size (B, beam_size), a maximum sequence length (max_seq_len), the number of heads (head_num), a head size (head_size), and the like. The K tensor may be stored in a memory in different dimensional order. For example, an exemplary order may be:
[batch_size, beam_size,head_num,max_seq_len,head_size].

Another exemplary order may be:
[batch_size, beam_size, max_seq_len, head_num,head_size].

FIG. 6 further shows storage of the K tensor in the memory and update of a corresponding K value based on best beams of a current time step. This example, for example, performs storage according to the above first order. A K value at a current token location is updated according to the best beams selected by the current time step to correspond to a K value of a token sequence that generates the best beams.

It may be known from the description of FIG. 6 that in the above operation, the cache of the K tensor is read twice and written once totally, where during rearrangement, the cache of the K tensor is read once and written once, and during decoding, the cache of the K tensor is read once. In some situations, when the dimensions of the K tensor, such as the batch size (batch_size), the beam size (B, beam_size), and the maximum sequence length (max_seq_len), are relatively large, the amount of IO generated by the above operation is very large, and the IO bottleneck is very obvious. Taking batch_size=16, beam_size=4, head_num=16, max_seq_len=120, and head_size=64 as an example, in the transformer model, there are 6 layers of decoders, the K tensor and the V tensor are stored as float32 types, and the total number of bytes is 360 M. With such a large quantity, hardware requires at least several milliseconds to complete operations. Therefore, it is urgent to provide an improved solution that may reduce processing time and overcome the above IO bottleneck.

Inventors note that the purpose of the above rearrangement is essentially to acquire correct beams (which are best beams selected by the previous time step) and a correct token sequence (which is a corresponding token sequence that generates the best beams) in the self-attention computing of the decoder. Therefore, if no rearrangement or partial rearrangement may achieve the purpose, the time of reading once and writing once caused by the rearrangement may be avoided or reduced.

Further, if no rearrangement is performed at all, a pointer or index is required to indicate the token sequence corresponding to the best beams (or the K/V value of the token sequence). However, when reading these K/V values according to the pointer or index, the cache of K/V in the beam_size and max_seq_len is discontinuous, so corresponding data is required to be loaded through cyclic traversal. In machine processing, cyclic sending of instructions will cause instruction delay time to exceed the time of reading cache, which greatly reduces the bandwidth of IO of the storage unit.

In view of the above factors, in the embodiment of the present disclosure, a local rearrangement scheme is proposed. In this scheme, the amount of data involved in each rearrangement is reduced, which means that the amount of IO of rearrangement reading/writing is reduced, and at the same time, the number of cyclic times of loading data is reduced, thus achieving the best overall performance.

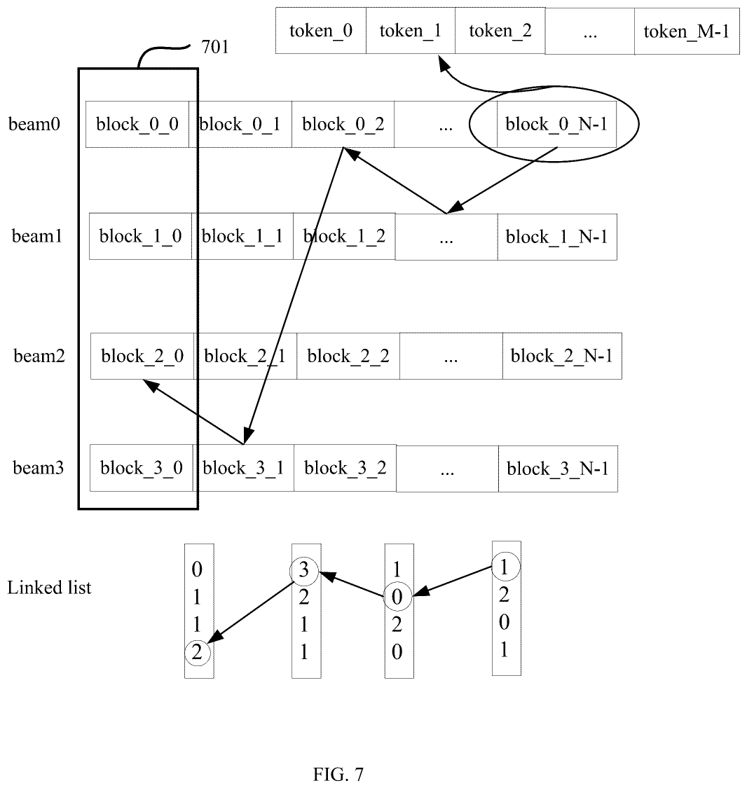

FIG. 7 illustrates a rearrangement processing strategy according to an embodiment of the present disclosure.

In the embodiment of the present disclosure, considering the large amount of data involved in each rearrangement, these pieces of data may be stored in blocks and rearranged only within the range of the blocks, thus reducing the amount of IO of the rearrangement.

As shown in the figure, to-be-rearranged intermediate variables (such as K/V tensors) may be partitioned according to the max_seq_len dimension. For example, the intermediate variables are evenly divided into N blocks, where each block corresponds to intermediate variables during a certain number (such as M=max_seq_len/N) of consecutive time steps. The thick frame 701 in the figure shows a 0th block, which corresponds to intermediate variables of 0th˜M−1-th time steps, and following blocks may be followed by analogy.

It may be understood that each block is required to store intermediate variables corresponding to B best beams. The figure shows B=4, which means that each block stores intermediate variables corresponding to four best beams including beam0, beam1, beam2, and beam3. More specifically, in a block, intermediate variables corresponding to one best beam include corresponding intermediate variables generated during M consecutive time steps. For example, a block_0_0 of a 0th block 701 caches intermediate variables of 0th˜M-1-th time steps corresponding to the beam0; a block_1_0 of the 0th block 701 caches intermediate variables of 0th˜M−1-th time steps corresponding to the beam1; a block_2_0 of the 0th block 701 caches intermediate variables of 0th˜M−1-th time steps corresponding to the beam2; and a block_3_0 of the 0th block 701 caches intermediate variables of 0th˜M−1-th time steps corresponding to the beam3. These intermediate variables correspond to corresponding tokens and are therefore represented by the corresponding tokens in the figure. Other blocks similarly cache corresponding data.

Further, blocks are linked by the index or pointer. Therefore, subsequent decoding access may jump to a corresponding block for access according to the index or pointer. Since the number of blocks is usually not too large, the number of jumps is not too large, which may reduce the number of cyclic times of loading data and shorten access time. Links between blocks are shown by arrows in the figure, through these links, a block sequence may be formed, which corresponds to best beams of a current time step.

In some implementations, this link relationship between blocks may be preserved using a linked list. In a single linked list, each node stores a current value and a pointer of a next node, so that the entire content may be indexed based on an address of a first node. In some embodiments of the present disclosure, each node of a linked list stores an index indicating that the best beams correspond within the previous block in the block sequence. For example, for the case of four best beams, assuming that an index of four best beams stored in a fourth node of the linked list is [1,2,0,1], an index of four best beams stored in a third node is [1,0,2,0], an index of four best beams stored in a second node is [3,2,1,1], and an index of four best beams stored in a first node is [0,1,1,2], based on a last node (such as the fourth node in the current example) in the linked list, all intermediate variables corresponding to the best beams may be acquired in turn. Specifically, according to a first index value (1) in the fourth node, a current best beam beam0 comes from a beam1 in a previous block; according to an index value corresponding to the beam1 in the third node, which is a second index value (0), the beam0 in the previous block comes from the beam0 in the previous block; according to an index value corresponding to the beam0 in the second node, which is a first index value (3), the beam0 in the previous block comes from the beam3 in the previous block; according to an index value (2) corresponding to the beam3 in the first node, a beam2 in the previous block is continued to be linked, thereby obtaining all corresponding data. FIG. 7 illustrates the above linking process with arrows.

The block rearrangement scheme of the embodiment of the present disclosure is described above in conjunction with FIG. 7. It may be known from the above description that, by storage in blocks and rearranging only the range within the associated blocks at a time, the amount of IO of rearrangement may be reduced. Further, by saving the link relationship between the blocks, each block may be connected in series to obtain data corresponding to the entire best beam. Since the number of blocks is usually not too large, the number of jumps is not too large in the decoding access, which reduces the number of cyclic times of loading data and shortens access time. Solutions of embodiments of the present disclosure will be described in detail in combination with drawings below.

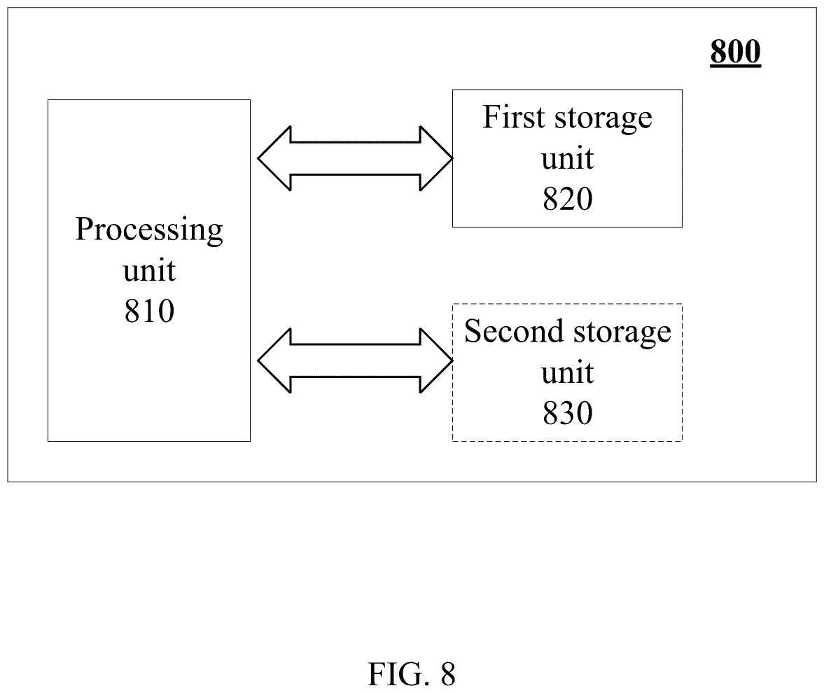

FIG. 8 is an exemplary structural diagram of a data processing apparatus according to an embodiment of the present disclosure. As shown in the figure, a data processing apparatus 800 includes a processing unit 810 and a first storage unit 820.

The processing unit 810 may perform various tasks. For example, the processing unit 810 is configured to run a neural network model. In the embodiment of the present disclosure, the neural network model includes a decoder based on an attention mechanism and may be, for example, a transformer model or other models based on the transformer model. Further, the decoder uses a beam search method to decode.

The first storage unit 820 may be configured with N storage blocks, where N>1, and each storage block is respectively associated with several successive time steps to cache intermediate variables generated by running the decoder by the processing unit 810 during the associated time steps.

In some implementations, the first storage unit 820 may be averagely divided into N storage blocks, and each storage block is associated with M successive time steps, where M may, for example, be equal to a maximum sequence length supported by 1/N decoders. For example, in an example where max_seq_len=120 and N=6, M=120/6=20, which means that each storage block caches intermediate variables generated by the decoder during 20 successive time steps. In this example, a first storage block block0 may cache intermediate variables of 0th˜19th time steps, a second storage block block1 may cache intermediate variables of 20th˜39th time steps, and so on, a sixth storage block block5 may cache intermediate variables of 100th˜119th time steps.

In some embodiments of the present disclosure, during the running of the neural network model, the processing unit 810 may be configured to implement a local rearrangement scheme of the present disclosure as follows: according to B candidate output sequences (B is a beam width or beam size beam_size, and B>1) of a decoder selected by a current time step, B groups of intermediate variables corresponding to the B candidate output sequences in the associated storage block of the current time step are rearranged; and based on the B candidate output sequences, B groups of intermediate variables of a predetermined time step range are read from a corresponding storage block of the first storage unit 820 to perform decoding of a next time step.

The previous example and the case of B=4 are continued. Assuming that the current time step is a 38th time step, an index of four candidate output sequences (or called four best beams) selected by the current time step is best_beam=[1,0,0,2]. In other words, a current best beam beam0 comes from the beam1 of the previous time step, a current best beam beam1 comes from the beam0 of the previous time step, a current best beam beam2 comes from the beam0 of the previous time step, and a current best beam beam3 comes from the beam2 of the previous time step. The storage block associated with the current time step is a block1, and intermediate variables corresponding to previous 20th-36th time steps in the block1 have been rearranged according to best beams of a 37th time step. At this time, in response to four best beams selected in a 38th time step, the intermediate variables of the 20th-37th time steps in the block1 are rearranged.

In some embodiments, the processing unit 810 may be configured to perform the above rearrangement in situ within the associated storage block. For example, the processing unit may read intermediate variables that are required to be rearranged from the associated storage block. For example, in the above example, the processing unit reads the intermediate variables of the 20th-37th time steps. Next, the processing unit may rearrange intermediate variables of these 18 time steps according to the index of the best beams best_beam=[1,0,0,2]. Specifically, data of an original beam1 is adjusted to a new beam0, data of an original beam0 is adjusted to a new beam1, data of the original beam0 is also adjusted to a new beam2, and data of an original beam2 is adjusted to a new beam3. Since the amount of data required to be rearranged is greatly reduced, the rearrangement may be performed in situ. In situ rearrangement may save caching resources, and no additional caching space is required to save the rearranged data.

When the decoding of the next time step is to be performed, four groups of intermediate variables of a predetermined time step range may be read from a corresponding storage block of the first storage unit 820 based on these four best beams.

Further, in some embodiments of the present disclosure, the data processing apparatus 800 further includes a second storage unit 830, which may be configured to cache link information indicating a storage block sequence, where the storage block sequence contains intermediate variables that generate the currently selected candidate output sequences.

In some implementations, the above link information may be stored in the form of a linked list. Specifically, each node in the linked list stores an index indicating that the candidate output sequences correspond within the previous block in the block sequence.

The processing unit 810 may maintain information in the linked list according to the progress of decoding. Since the linked list stores a link relationship between storage blocks, it is only necessary to record link information accordingly when processing to the boundary of the storage block. In some embodiments, in response to a case where the current time step is the first time step corresponding to the associated storage block, based on the candidate output sequences selected by the current time step, the processing unit may determine the corresponding index in the previous storage block and store the index in the corresponding node of the linked list.

For example, assuming that the current time step is a 40th time step, an index of four candidate output sequences (or called four best beams) selected by the current time step is best_beam=[3,2,1, 1]. In other words, the current best beam beam0 comes from the beam3 of the previous time step (39th time step), the current best beam beam1 comes from the beam2 of the previous time step, the current best beam beam2 comes from the beam1 of the previous time step, and the current best beam beam3 comes from the beam1 of the previous time step. The storage block associated with the current time step is a block2, and the current time step is the first time step in the corresponding successive time steps (40˜59) in the block2. At this time, intermediate variables are not cached in the block2, so no rearrangement is required, but intermediate variables of these 20 successive time steps in the previous storage block block1 have been sorted in turn according to best beams of each step in these 20 successive time steps and are no longer changed. At this time, a link relationship between the current storage block block2 and the previous storage block block1 is required to be recorded accordingly, which is the above index best_beam=[3,2,1,1]. Specifically, the above index best_beam=[3,2,1,1] is saved in the second node of the linked list.

Accordingly, intermediate variable corresponding to the best beams of the first time step (such as the 40th time step) may be updated in the block2.

Later, in the decoding of the next time step, corresponding intermediate variables may be read from corresponding storage blocks in turn according to the index stored by each node of the linked list. For example, continuing with the above example, in a 41st time step, B groups of intermediate variables (intermediate variables of the 40th time step in this example) respectively corresponding to B best beams are read from the current storage block block2. Next, according to the index [3,2,1,1] in the second node of the linked list, data in a corresponding location is read from the previous storage block block1. For example, for the current beam0, the beam3 in the block1 is read; for the current beam1, the beam2 in the block1 is read, and so on. Next, according to the index in the first node of the linked list, corresponding data is read from the previous storage block block0. The technical implementation of this aspect may be better understood by referring to the content and reading mode of each node of the linked list described by example in FIG. 7.

Optionally or additionally, in some embodiments, the processing unit 810 may be further configured to: in response to a case where the number of time steps exceeds a maximum sequence length S supported by a decoder, return to the first storage block to cache intermediate variables that are generated by the decoder during the associated time step; and read B groups of intermediate variables of last S time steps to perform decoding of a next time step.

In these embodiments, when the number of decoded time steps exceeds the maximum sequence length S but the task is not finished, the decoding may be continued. At this time, since the sequence length is relatively large, initial information (such as a 0th word) may not have much relevance to following information (such as an S+-th word), so the decoded sequence may be truncated, such as using only a decoding sequence consisting of the nearest S time steps and discarding previous decoding information. Therefore, the above storage block may be recycled in these embodiments. Specifically, when the time step exceeds the last time step associated with the last storage block, this process goes back to the first storage block and overwrites data of the first time step of the first storage block. One flag bit may be used to record this kind of “back” storage.

Additionally, it may be known from the above description that the actual processing time of the above block local rearrangement is closely related to the number of blocks in the data or storage area. In some embodiments of the present disclosure, the above number N of storage blocks may be selected to minimize the processing time. It may be known from the above analysis in combination with FIG. 6 that the processing time mainly includes two parts: time of rearranging intermediate variables and time of reading intermediate variables by a decoder. The embodiment of the present disclosure minimizes the sum of time of the two parts by selecting the number N of blocks.

By analyzing the composition of the above processing time, the number N of storage blocks may be determined based on one or more of following factors: the total amount of data of intermediate variables required to be cached; a read bandwidth of the storage unit; a write bandwidth of the storage unit; and instruction delay time.

It is assumed that the total amount of data of intermediate variables (such as K/V tensors) is Z bytes, the maximum sequence length is S, N is the number of blocks, the read bandwidth is RB, the write bandwidth is WB, and the instruction delay time is D. Since the rearrangement is performed only in the storage block, the total number of bytes of the rearrangement cycles between 0 and Z/N; in other words, according to the change in the number of time steps corresponding to each storage block, the amount of IO that may be rearranged may be averaged to 0.5*Z/N. Time T1 of rearranging the intermediate variables may be computed as follows:
T1=1 read time+1 write time=0.5*Z/N/RB+0.5*Z/N/WB.

Time T2 of reading the intermediate variables by the decoder may be computed as follows:
T2=read-out time of all data+jump time between blocks=Z/RB+N*D.
Total time T=T1+T2=0.5*Z/N/RB+0.5*Z/N/WB+Z/RB+N*D.

In order to divide each block equally, a constraint condition S % N=0 may be added, which means that the maximum sequence length may be evenly divided by the number N of blocks.

It may be known from the above formula that the larger N is, the smaller T1 is, but the larger T2 is. Therefore, there may be an optimal N that minimizes the sum of T1 and T2. In the above example where S=120, the number of blocks determined based on the above principle is N=6.

Through the data processing apparatus provided above, through block storage of intermediate variables required to be rearranged and rearrangement of the intermediate variables within blocks, the solution of the present disclosure may reduce the amount of IO caused by the rearrangement. Further, each rearrangement is performed in situ in the storage block, so there is no need to configure additional storage space to support the rearrangement, thus reducing memory requirements. Additionally, the method provided in the embodiment of the present disclosure has strong generality and has no special requirements for hardware, so the method may be applied to any hardware system. The embodiment of the present disclosure further provides a method for performing a neural network model.

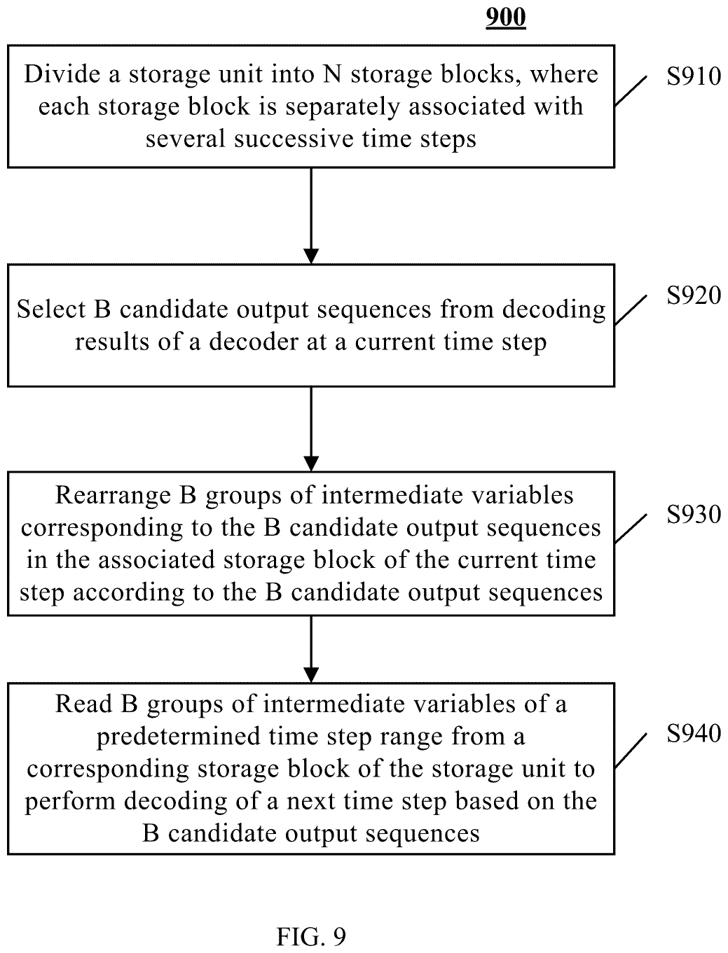

FIG. 9 shows an exemplary flowchart of a method 900 for performing a neural network model according to an embodiment of the present disclosure. This neural network model includes a decoder based on an attention mechanism, and the decoder adopts a beam search method as a decoding strategy.

As shown in the figure, in step S910, a storage unit may be divided into N storage blocks, where N>1, and each storage block is separately associated with several successive time steps to cache intermediate variables generated by the decoder during the associated time steps. This step may be performed in advance to configure a corresponding storage unit.

Next, in step S920, B candidate output sequences are selected from decoding results of the decoder at a current time step, where B>1. This step is to select B best beams in the beam search.

Next, in step S930, according to the B candidate output sequences, B groups of intermediate variables corresponding to the B candidate output sequences in the associated storage block of the current time step are rearranged.

In some embodiments, the above rearrangement is performed in situ within the associated storage block.

Finally, in step S940, based on the B candidate output sequences, B groups of intermediate variables of a predetermined time step range are read from a corresponding storage block of the storage unit to perform decoding of a next time step.

Additionally, in some embodiments, the method 900 further includes caching link information indicating a storage block sequence, where the storage block sequence contains intermediate variables that generate the currently selected candidate output sequences. In a further embodiment, the above link information may be stored as in the form of a linked list, where each node in the linked list stores an index indicating that the candidate output sequences correspond within a previous storage block in the storage block sequence. Specifically, the method 900 may also be used to maintain the linked information in the linked list by: in response to a case where the current time step is a first time step corresponding to the associated storage block, based on the candidate output sequences selected by the current time step, determining a corresponding index in a previous storage block and storing the index in a corresponding node of the linked list.

Therefore, in step S940, specifically, according to an index stored by each node of the linked list, corresponding intermediate variables may be read from a corresponding storage block to perform decoding of a next time step.

Optionally or additionally, in some embodiments, the method 900 further includes: in response to a case where the number of time steps exceeds a maximum sequence length S supported by the decoder, returning to a first storage block to start to cache intermediate variables that are generated by the decoder during the associated time step; and reading B groups of intermediate variables of last S time steps to perform decoding of a next time step.

The process of executing the neural network model of the embodiment of the present disclosure is described above in conjunction with the flowchart. It may be understood that features of the above rearrangement processing related to the beam search in the execution of the neural network model in combination with the hardware structure are also applicable to the above method, and the related description will not be repeated here. Similarly, some embodiments of the present disclosure also provide a chip and board card containing a data processing apparatus, which may contain corresponding features described above and will not be repeated here.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiogramic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. With respect to a connection between different units or components, the connection discussed above in combination with drawings may be direct or indirect coupling between the units or components. In some scenarios, the direct or indirect coupling involves a communication connection using an interface. The communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated. In some implementation scenarios, the integrated unit may be implemented in the form of a software program unit. If the integrated unit is implemented in the form of the software program unit and sold or used as an independent product, the integrated unit may be stored in a computer-readable memory. Based on this, when the solution of the present disclosure is embodied in the form of a software product (such as a computer-readable storage medium), the software product may be stored in a memory. The software product may include several instructions used to enable a computer device (which may be a personal computer, a server, or a network device, and the like) to perform part or all of steps of the method of the embodiments of the present disclosure. The memory includes but is not limited to an USB, a flash disk, a read only memory (ROM), a random access memory (RAM), a mobile hard disk, a magnetic disk, or an optical disc, and other media that may store a program code.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium, and the like). For example, the appropriate storage medium may be a resistive random access memory (RRAM), a dynamic random access memory (DRAM), a static random access memory (SRAM), an enhanced dynamic random access memory (EDRAM), a high bandwidth memory (HBM), a hybrid memory cube (HMC), the ROM, and the RAM, and the like.

Although a plurality of embodiments of the present disclosure have been shown and described, it is obvious to those skilled in the art that such embodiments are provided only as examples. Those skilled in the art may think of many modifying, altering, and substituting methods without deviating from the thought and spirit of the present disclosure. It should be understood that various alternatives to the embodiments of the present disclosure described herein may be adopted in the practice of the present disclosure. The attached claims are intended to limit the scope of protection of the present disclosure and therefore to cover equivalents or alternatives within the scope of these claims.

What is claimed:

1. A data processing apparatus, comprising:
a processing unit, configured to run a neural network model, wherein the neural network model comprises a decoder based on an attention mechanism, and the decoder uses a beam search method to decode; and
a first storage unit, configured with N storage blocks, wherein N>1, and each storage block is separately associated with several successive time steps to cache intermediate variables generated by the decoder during the associated time steps, wherein
the processing unit is further configured to:
according to B candidate output sequences of the decoder selected by a current time step, wherein B>1, rearrange B groups of intermediate variables corresponding to the B candidate output sequences in the associated storage block of the current time step; and
based on the B candidate output sequences, read B groups of intermediate variables of a predetermined time step range from a corresponding storage block of the storage unit to perform decoding of a next time step.

2. The data processing apparatus of claim 1, further comprising:
a second storage unit, configured to cache link information indicating a storage block sequence, wherein the storage block sequence comprises intermediate variables that generate the currently selected candidate output sequences.

3. The data processing apparatus of claim 2, wherein the link information is stored in the form of a linked list, and each node in the linked list stores an index indicating that the candidate output sequences correspond within a previous storage block in the storage block sequence.

4. The data processing apparatus of claim 3, wherein the processing unit is further configured to:
in response to a case where the current time step is a first time step corresponding to the associated storage block, based on the candidate output sequences selected by the current time step, determine a corresponding index in the previous storage block; and
store the index in a corresponding node of the linked list.

5. The data processing apparatus of claim 4, wherein the processing unit is further configured to:
according to an index stored by each node of the linked list, read corresponding intermediate variables from a corresponding storage block in turn to perform decoding of a next time step.

6. The data processing apparatus of claim 1, wherein the processing unit is further configured to perform rearrangement in situ within the associated storage block.

7. The data processing apparatus of claim 1, wherein the processing unit is further configured to:
in response to a case where the number of time steps exceeds a maximum sequence length S supported by the decoder, return to a first storage block to cache intermediate variables that are generated by the decoder during the associated time steps; and
read B groups of intermediate variables of last S time steps to perform decoding of a next time step.

8. The data processing apparatus of claim 1, wherein the number N of storage blocks is selected to minimize the sum of time of rearranging the intermediate variables and instruction delay of reading the intermediate variables by the decoder.

9. The data processing apparatus of claim 8, wherein the number N of storage blocks is determined based on one or more of followings:
the total amount of data of intermediate variables required to be cached;
a read bandwidth of the storage unit;
a write bandwidth of the storage unit;
instruction delay time; and
a divisible relationship between the maximum sequence length supported by the decoder and the number N of storage blocks.

10. (canceled)

11. (canceled)

12. A method for performing a neural network model, wherein the neural network model comprises a decoder based on an attention mechanism, and the decoder uses a beam search method to decode, and the method comprises:
dividing a storage unit into N storage blocks, wherein N>1, and each storage block is separately associated with several successive time steps to cache intermediate variables generated by the decoder during the associated time steps;
selecting B candidate output sequences from decoding results of the decoder at a current time step, wherein B>1;
according to the B candidate output sequences, rearranging B groups of intermediate variables corresponding to the B candidate output sequences in the associated storage block of the current time step; and
based on the B candidate output sequences, reading B groups of intermediate variables of a predetermined time step range from a corresponding storage block of the storage unit to perform decoding of a next time step.

13. The method of claim 12, further comprising:
caching link information indicating a storage block sequence, wherein the storage block sequence comprises intermediate variables that generate the currently selected candidate output sequences.

14. The method of claim 13, further comprising:
storing the link information in the form of a linked list, wherein each node in the linked list stores an index indicating that the candidate output sequences correspond within a previous storage block in the storage block sequence.

15. The method of claim 12, further comprising:
in response to a case where the current time step is a first time step corresponding to the associated storage block, based on the candidate output sequences selected by the current time step, determining a corresponding index in the previous storage block; and
storing the index in a corresponding node of the linked list.

16. The method of claim 135, further comprising:
according to an index stored by each node of the linked list, reading corresponding intermediate variables from a corresponding storage block in turn to perform decoding of a next time step.

17. The method of claim 12, further comprising: performing rearrangement in situ within the associated storage block.

18. The method of claim 12, further comprising:
in response to a case where the number of time steps exceeds a maximum sequence length S supported by the decoder, returning to a first storage block to start to cache intermediate variables that are generated by the decoder during the associated time steps; and
reading B groups of intermediate variables of last S time steps to perform decoding of a next time step.

19. The method of claim 12, further comprising:
selecting the number N of storage blocks to minimize the sum of time of rearranging the intermediate variables and instruction delay of reading the intermediate variables by the decoder.

20. The method of claim 19, further comprising: determining the number N of storage blocks based on one or more of followings:
the total amount of data of intermediate variables required to be cached;
a read bandwidth of the storage unit;
a write bandwidth of the storage unit;
instruction delay time; and
a divisible relationship between the maximum sequence length supported by the decoder and the number N of storage blocks.
